(19) United States
(12) Patent Application Publication
(10) Pub. No.: US 2013/0212028 A1
(43) Pub. Date: Aug. 15, 2013

(54) SYSTEMS AND METHODS FOR LEVERAGING SOCIAL CONTEXT IN CONSUMER TRANSACTIONS

(71) Applicant: MonkeyContact, Inc., (US)

(72) Inventor: Tim Delhaes, Bremen (DE)

(73) Assignee: MonkeyContact, Inc., Providencia (CL)

(21) Appl. No.: 13/764,859

(22) Filed: Feb. 12, 2013

Related U.S. Application Data
(60) Provisional application No. 61/598,702, filed on Feb. 14, 2012.

(51) Int. Cl. G06Q 30/02; G06Q 50/00

(52) U.S. Cl. CPC G06Q 30/02; G06Q 50/01
USPC 705/301

(57) ABSTRACT

A system for discovering relationships among users of a plurality of electronic social networking and messaging platforms includes a memory for storing computer executable instructions and a processor for retrieving and executing the computer executable instructions. When the instructions are executed, the processor instantiates an application that identifies characteristics and interests of the user and compiles a vector representing the characteristics and interests of the user. The vector is compared with other vectors representing identities and interests of other individuals, and based on the comparison, a subset of the other individuals having a relationship to the user based on one or more of the other individuals identities and interests is identified. A graphical representation of an actionable list of the subset of individuals is presented to the user such that the user may select one of the individuals from the list for subsequent communication.

### CROSS-REFERENCE TO RELATED APPLICATIONS

This application claims priority to and the benefit of U.S. Provisional Application Ser. No. 61/598,702, filed on Feb. 14, 2012, which is hereby incorporated herein by reference in its entirety.

### FIELD OF THE INVENTION

The invention relates generally to social networking, and more particularly to systems and methods providing users with relevant information about objects, people and environments within their social context.

### BACKGROUND OF THE INVENTION

Human brains can recall and relate to a limited amount of people and information, in that an individual can typically only remember no more than a few hundred names, faces, interests, and things. For example, the people we interact with, what they do for a living, their hobbies, where they live, the pets they own, and what type of car they drive. This knowledge, along with the relationships among these individuals, facilitates communication and consultation regarding advice and opinions that drive help us take decisions. Discovering these relationships is an ongoing human activity.

Information technology significantly improves one's ability to establish and maintain more relationships and access more information. We can “relate” to more people (e.g., maintain a list of 5,000 business contacts) and do so in an abstract/virtual world and receive “tweets” and “updates” every minute.

The challenge, however, is that when humans consume information (see a web site, read a tweet, meet a person, etc.) our brain cannot immediately understand how this information relates to ourselves or the people we know. This “social context” is relevant in that without it is impossible for us to assign meaning and value to the information and make decisions accordingly.

On-line social networks have become an integral part of daily life and attempt to address this challenge. Beyond simply maintaining friendships and professional networks, companies use social networks for marketing and communication purposes. A consumer is just as likely to visit a company's “Facebook Page” as they are the company's own homepage.

Typically, members define their group of friends in a social network by compiling a list of acquaintances and colleagues based on comment interests, experiences, family relationships, school ties and other connections. Each individual typically has the ability to define the parameters governing her community of friends, such as who she wants to interact with, who she shares information with, who has access to her personal data and who to request as a friend or connection. Facebook, LinkedIn, MySpace and Orkut are typical examples of such social networks. Contact management applications such as Gmail and Outlook contact lists may also provide similar functionality, albeit limited.

Users of these services tend to assume different personalities and share different types of information in each social network. In a travel community a user might disclose his past and future travel destinations while in an investors community people might share their interests in specific markets or companies. In another community people might openly share their personal activities and hobbies. In group buying sites like BuyWithMe and GroupOn, subscribers are more apt to share their experiences with members of their own network and trust recommendations and reviews from others in their network as opposed to the general public.

Discovering these relationships beyond the boundaries of specific interest often leads to surprising results. An entrepreneur might find an investor through a shared hobby or a man might meet his future wife at a business conference. While these “discoveries” tend to happen naturally in real-life occasions such as networking events and parties, such discoveries in the virtual world are usually limited due to the fact that ones personal profiles (hobbies, travel plans, etc.) are kept in independent information silos that do not share the information.

Therefore a new approach is needed to better discover these relationships that allows us to take better decisions which in turn can lead to new ways of promoting and selling products.

### SUMMARY OF THE INVENTION

Various embodiments of the invention provide methods and supporting systems for marketing, promoting and selling goods and services based on personal profiles and relationships. In one aspect, a system for discovering relationships among users of a plurality of electronic social networking and messaging platforms includes a memory for storing computer executable instructions and a processor for retrieving and executing the computer executable instructions. When the instructions are executed, the processor instantiates an application that identifies characteristics and interests of the user and compiles a vector representing the characteristics and interests of the user. The vector is compared with other vectors representing identities and interests of other individuals, and based on the comparison, a subset of the other individuals having a relationship to the user based on one or more of the other individuals identities and interests is identified. A graphical representation of an actionable list of the subset of individuals is presented to the user such that the user may select one of the individuals from the list for subsequent communication.

### BRIEF DESCRIPTION OF THE FIGURES

FIG. 1 is a flow chart of a method for selecting a product for purchase according to one or more embodiments of the invention.

FIG. 2 is a flow chart of a method for determining relevant information regarding a potential purchase according to one or more embodiments of the invention.

FIG. 3 is an illustration of an environment in which various embodiments of the invention may be implemented.

FIG. 4 is a flow chart of a method for determining relationship strengths according to one or more embodiments of the invention.

FIG. 5 illustrates one possible embodiment of a relationship vector.

FIG. 6 is a flow chart of a method for generating an identity vector according to one or more embodiments of the invention.

FIG. 7 illustrates another possible embodiment of an identity relationship vector.

FIG. 8 is a flow chart of an alternative method for generating an identity vector according to one or more embodiments of the invention.

FIG. 9 illustrates another possible embodiment of an identity relationship vector.

FIG. 10 diagrams the relationships among users, objects and personas according to various embodiments of the invention.

FIG. 12 illustrates an actions listing according to various embodiments of the invention.

Other features of the present embodiments will be apparent from the accompanying drawings and from the disclosure of the various embodiments.

### DESCRIPTION OF THE INVENTION

In one particular use of the invention, a user considering buying a tablet computer is browsing various web sites for alternatives. He may review manufacturer web sites (e.g., Apple, Samsung), retail web sites (BestBuy) and/or consumer information sites (CNET, epinions, etc.) to obtain information on specifications, functionality, price, reliability, etc. While on one of the websites, the user considers a particular model (for example, while on the Samsung website he reviews the specs of the Samsung Galaxy Tablet) and wonders if he should buy it.

The user may initiate a search for the product using an embedded search function on the website, a generic search engine (Google, Yahoo!, Bing, etc.) to find information about the product, or may simply navigate though pages and/or menus to fine a particular product or product category. In other instances, the user may enter or select certain product characteristics (e.g., LCD TV, 60″ screen, 3D display, <$2500) that are then used to identify a product or collection of products.

Among other features, the invention provides the user with a “social context” button. The button may be embedded on or added to the website using a scripting language, part of the operating system, or, in some instances utilize frames, links or other objects. When the button or object is selected by the user, a new window or frame opens and is presented to the user. The window lists the people in his social network that are using, have recently bought, have tweeted about or recently reviewed the tablet. The list may include the people's names, images, photos, monikers, usernames, phone numbers, email addresses, avatars or other identifying information. The list may be compiled from the same website being viewed by the user, or, in some instances, from other websites, social network platforms or databases that sell, license or provide access to their user information. In some cases, the system alerts the user about relationships it has discovered, such as “Peter just tweeted about the product”, “John is selling his LCD TV” etc. without the user taking any action.

In some versions, the user may filter out reviews from people neither he, nor his social contacts are connected to, reviews from specific individuals (e.g., reviews by someone known to be unnecessarily harsh or, alternatively, not discerning enough), and, in some cases, using compound filtering parameters. Compound parameters may combine two or more filter criteria, such as ignoring comments from a particular user regarding a certain technology, or only accepting comments authored by a set of individuals within the past two months.

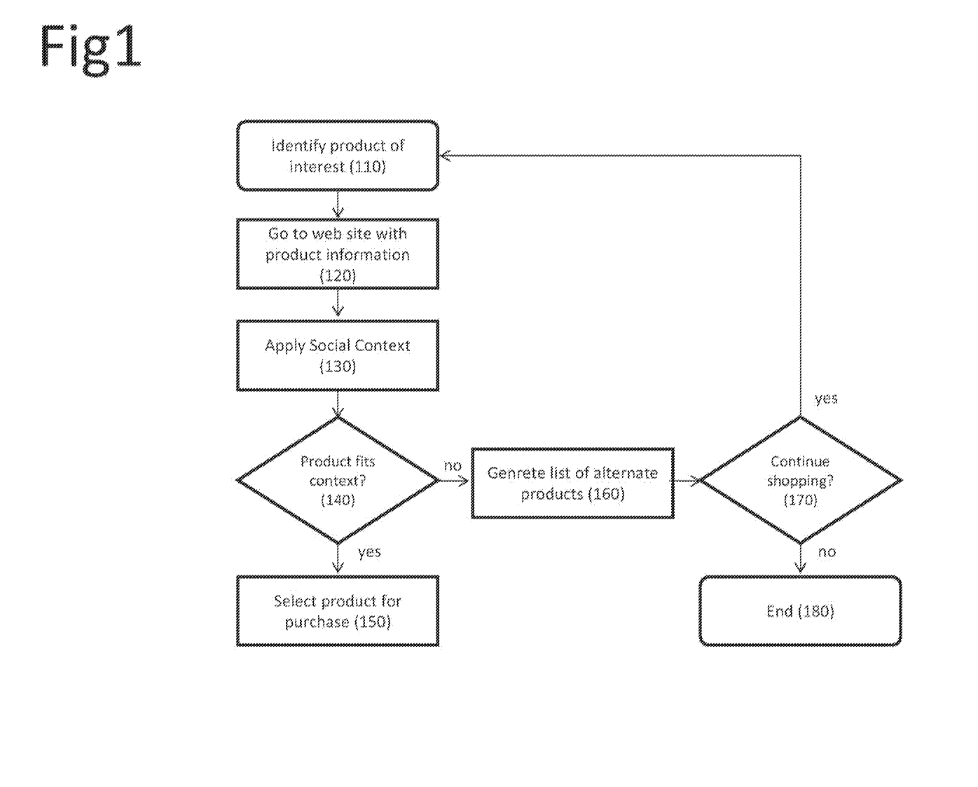

In some cases, the list may also include an identifying note or icon suggesting certain people that are considered knowledgeable on this particular product and/or this type of product. By following one of the suggested links, the user can review and explore opinions posted by trusted friends about the product and discover competing offers for the product. By continuing to follow subsequent links, he may view additional opinions from the people in his extended network—i.e., individuals that may be two or more degrees of separation from him, or so-called “friends of friends.” Once a purchase decision is made, the selected item is added to his shopping cart, as illustrated in FIG. 1. In some cases where the opinions and/or offers suggest alternative or additional products, the user may chose to purchase an alternative item and/or accessories for the item, such as batteries, a case or cover, additional memory, a charger, games, apps, etc. In selected embodiments, the user may have been directed to an alternative website (e.g., the user initially searched on Amazon but a friend tweeted that high-quality used versions are available on eBay, or is selling his device on Craigs List) and the purchase may be consummated on the alternative website. In effect, the user was able to leverage his social network to find trusted, timely information about a potential purchase by leveraging the members of his social network.

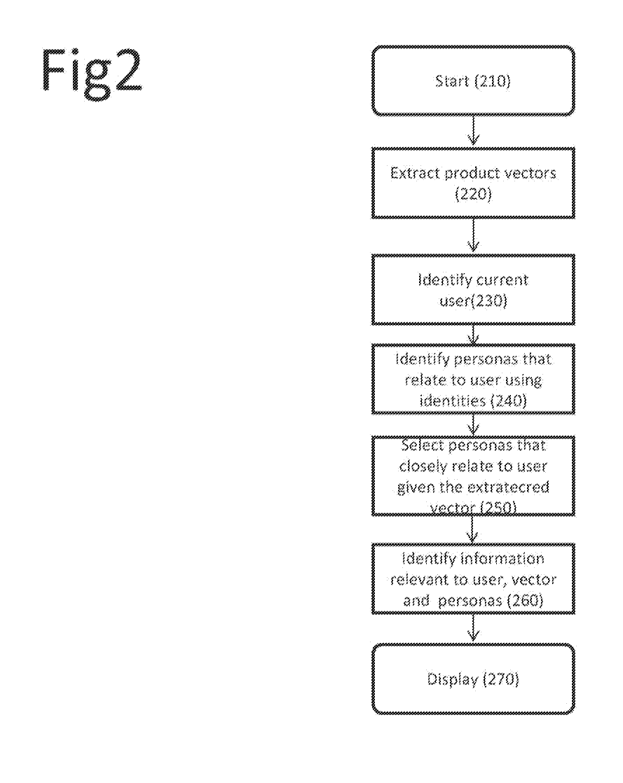

FIG. 2 illustrates an exemplary process for providing a user with social context regarding the product and/or product characteristics. Initially, vectors are extracted from the web page [220] that facilitate the identification and association of metadata with the product. Using the Galaxy tablet example referred to above, the system may extract tokens such as “Samsung galaxy tablet”, “tablet”, and “Samsung.” The process uses one or more of voice or image recognition, website metadata, photos, video clips, audio clips and other information to extract the tokens from the URL and/or content.

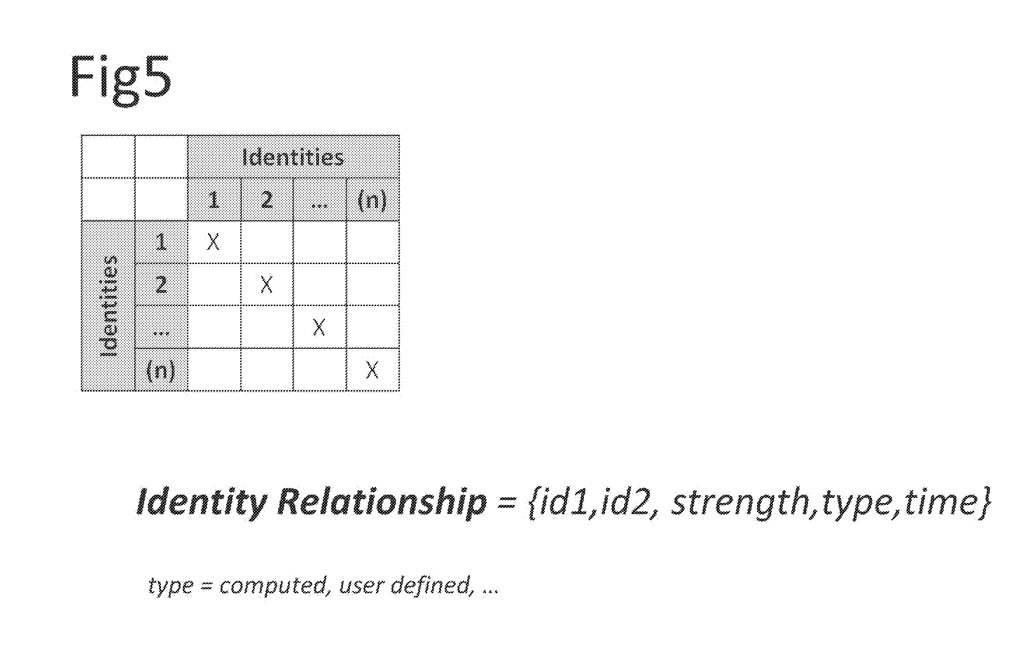

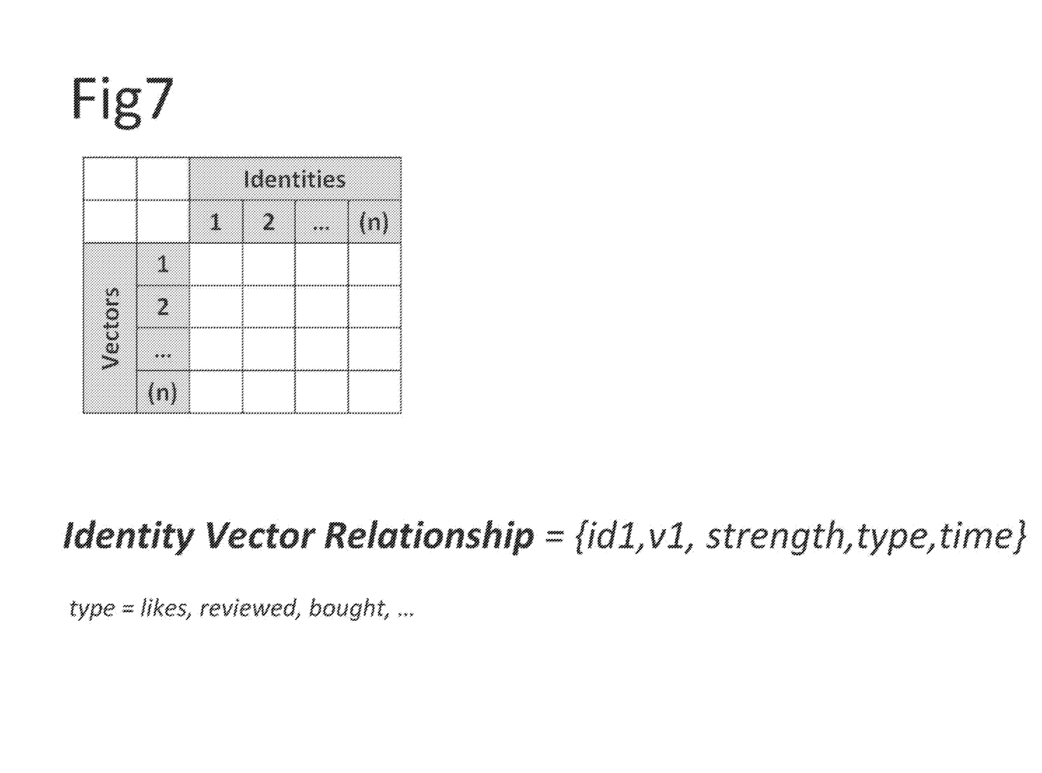

Identifying information related to individuals known to have “significant” connections to the user (referred to herein as “personas”) and that are closely related to the given vectors is obtained. The connections used to identify the personas may be direct (e.g., contacts in the users address book, friends on Facebook, connections on LinkedIn, etc.) or indirect (e.g: common vectors, browsing habbits, etc). The strength, type and time of the relationship is calculated automatically and/or defined by this and other users manually. This is done by resolving the relationship between identities and vectors as shown in FIG. 7 and grouping the identities. This is accomplished by using the relationship of identities between themselves as shown in FIG. 5. More specifically, every persona comprises multiple identities that relate to each other with acertain strength. This strength can be defined directly by the user and/or calculated.

In general, the user is identified and all contacts (or as also used below, “identities”) of each social network (and personal tools) are retrieved, as a user will often own, control or otherwise manage multiple online identities (e.g., Facebook accounts, LinkedIn accounts, email addresses, etc.). By analyzing the contact information retrieved for an individual user from public sources, the system calculates probabilities that multiple identities are owned, controlled and managed by the same user. The system then creates groups the identities accordingly.

In one embodiment, the system assumes that identities (1) are unique and (2) in majority of cases managed by a single human being. When a contact record contributed by a user or obtained from a public source contains at least two identities, there is a probability that these two identities belong to the same user. For example, I may have a person's email and Facebook URL. If this pattern repeats and little contradiction is found (another user indicating that the user's email is associated to a different Facebook account or phone number) there is an increasing probability that these identities belong to the same group.

These groups are referred to herein as “personas” which represents a set of identities that relate to each other with a certain probability. With increasing information about identities, the margin of error decreases and it allows the system to eliminate and flag non-human identities, such as bots or accounts attributed to companies. By analyzing and indexing the information identities have published (tweets, professional profiles, etc.) and what other users published about that identity (e.g., Facebook comments), vectors are created for each persona. In some instances the vectors have a different “strength” based on time sensitivity (decay) and/or a type of relationship between the individuals. This facilitates the selection of the personas that are most closely related to the user.

Referring again to FIG. 2, the current user is identified [240] and the personas that are most closely related to the user in the context of the given vectors are retrieved. The process of resolving identity and vector relations are described in greater detail below with reference to FIGS. 5 and 7. Additional information related to the personas such as product reviews, tweets, photos, videos and any other kind of publications [260] are retrieved and prioritized. The retrieved information (or some subset, prioritized list, etc.) is displayed in context with the identified personas [270]. The information itself as well as the way it is displayed may be further personalized depending on the users context, intention and types of relationships. The intention and context may be identified from the web site itself, usage history or behavior of other users.

As a result, the user can access and act upon product information in the context of people whose opinion or social connections can be trusted. In addition, the user can see alternatives to the original product, which may generate a higher ‘social score’ with the user's context.

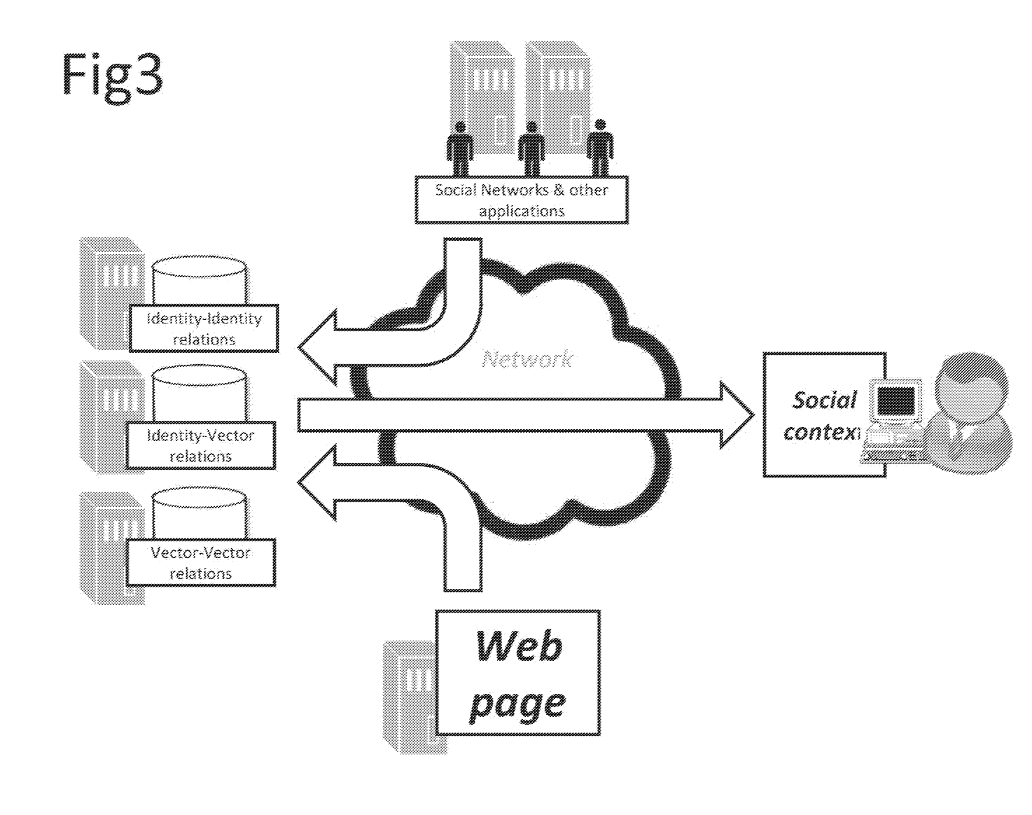

In one implementation, the system includes of a combination of server and client components as illustrated in FIG. 3. When the user accesses an object using a web browser or any other application, the vectors or that object embedded in the page are extracted and sent to the server. The server then resolves relationships between the vectors, personas, and related vectors, as detailed in the steps above and returns the social context for the original object. Alternatively, some of the information can be stored directly on the users device, in the client application or the entire systems can be implemented as a peer-to-peer system.

In some implementations the user can access an object within a mobile application. For example, in a social game environment, the user may need to decide whether to buy a virtual item in the game's “market.” Prior to making the decision, he can consult his social context, e.g., contacts within his social network who are knowledgeable about the matter. To facilitate the decisions, vectors for the object can be embedded into the object information. Further, social contacts can be pre-loaded onto the mobile device to speed up persona selection.

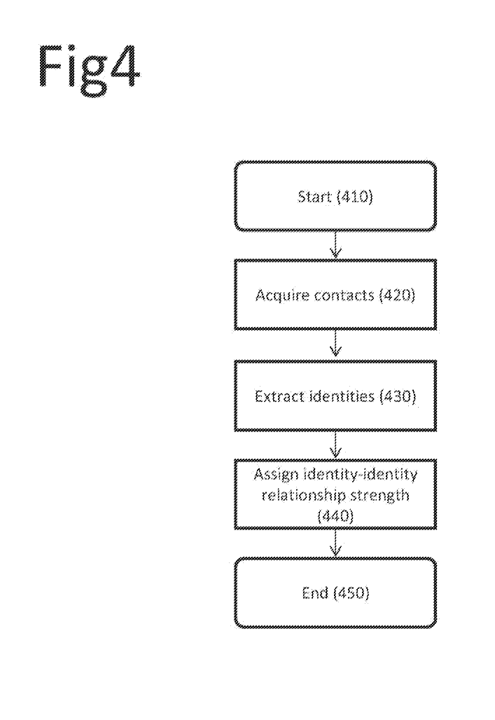

In some implementations the system sets up user device and/or software components to improve user experience and quality of recommendations. During setup the servers connect to the users social networks, tools and devices as shown in FIG. 4. Initially, the system identifies all user contacts [410] and extracts identities [420]. Values, types and times are assigned to each relationship as shown in FIG. 5. The relationships between the identities can be defined by specific users or automatically by the system including data contributed by other users. Additionally, the information can be enhanced using information obtained from public or private sources, e.g., government, commercial, and/or other databases.

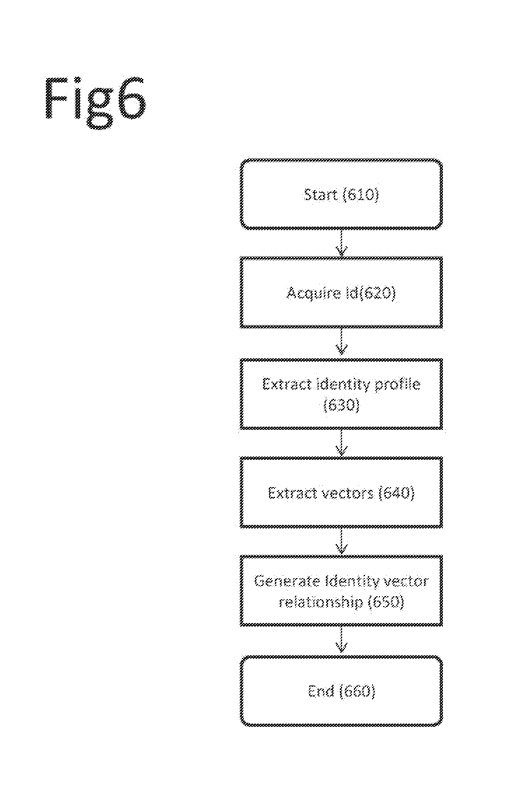

The system then gathers information about the relationships of identities to different vectors as shown in FIG. 6. For every identity the system finds, information from the user's social networks, tools and devices may be gathered, as well as from other public and private sources [640]. The vector and the relationship may be stored [650] as illustrated in FIG. 7.

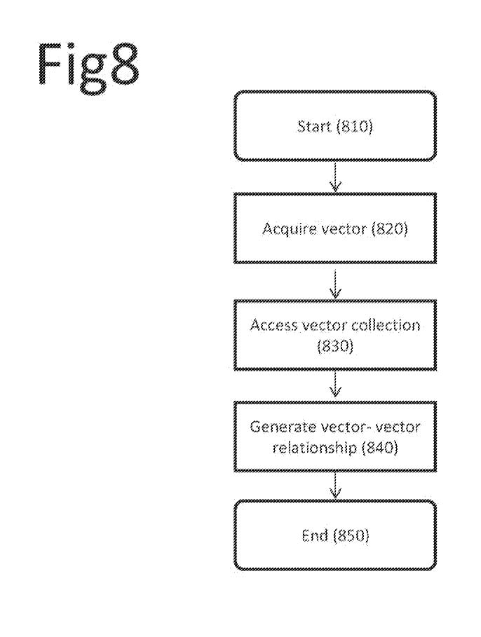

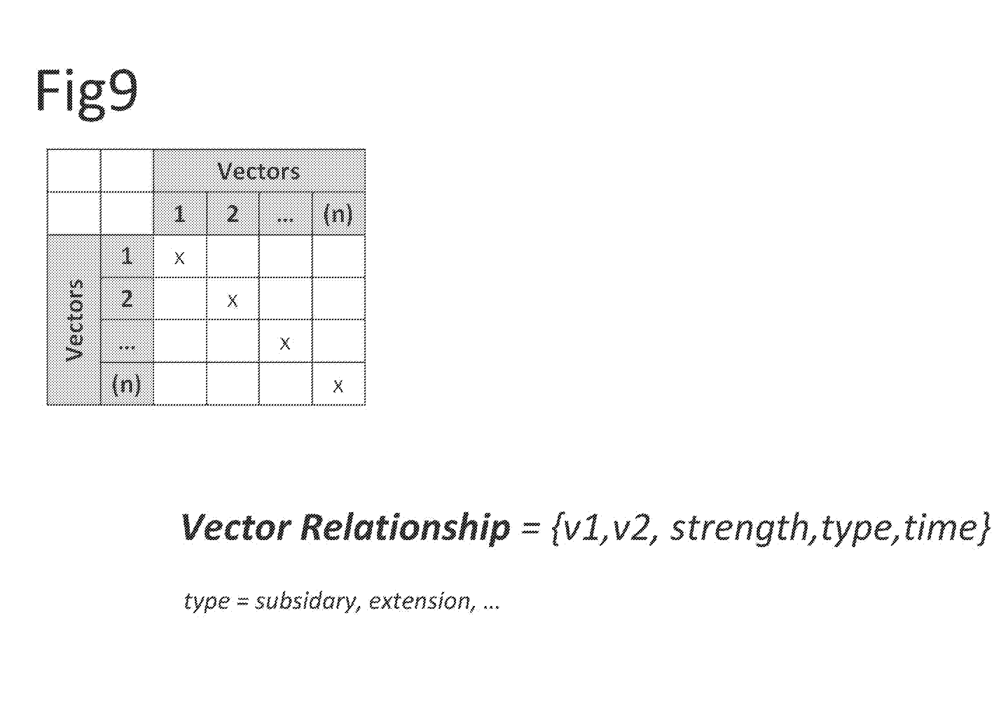

The system also generates relationships among different vectors as shown in FIG. 8. The relationships between vectors can be established based on manual input, information contributed by users or private and public information in accessible networks. The vector relationships may be stored as shown in FIG. 9.

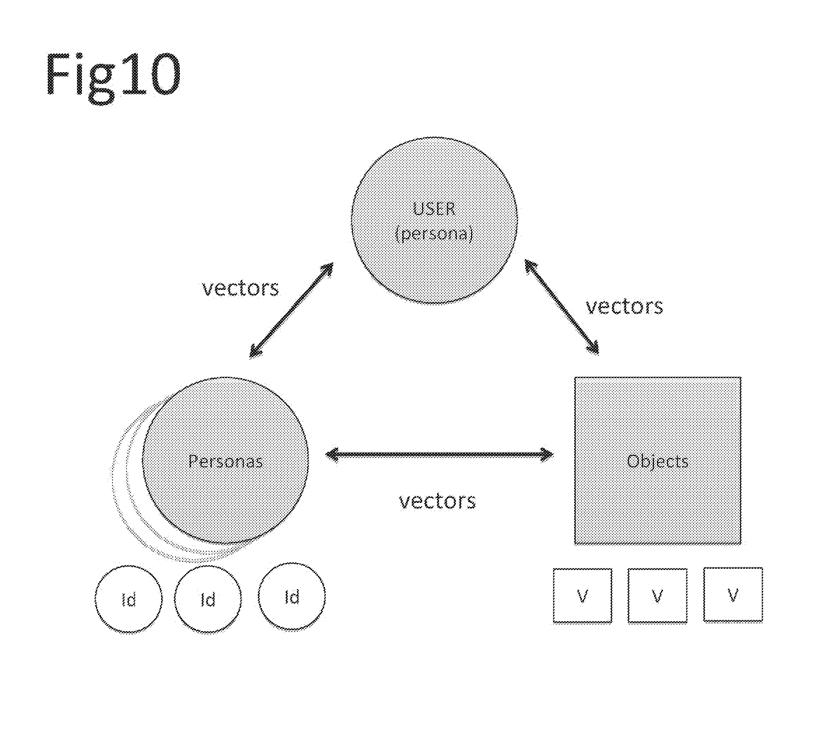

As shown in FIG. 10 the system allows to discover and/or establish relationships between users, personas, and objects.

When any two of the three types are known, the system enables the user to identify and/or act upon the third “missing link.”

In the tablet shopping example referred to above, the system receives user and object information as input and returns a set of personas with their respective list of related objects.

The personas returned by the system provide the user with a better understanding on how an object (e.g., a “tablet”) relates to the people he knows. It also allows the user to identify personas that have strong ties to these types of objects (e.g., “editor of a gadget magazine”). The objects related to each persona provide the users with the opportunity to discover more relevant information related to the current object (e.g., “tablets of other manufacturers”). In addition, the system filters out irrelevant information such as product reviews that are not trustworthy, out of date, related to the wrong product, etc. In some implementations, the user can add personas to his social context in the context of the object.

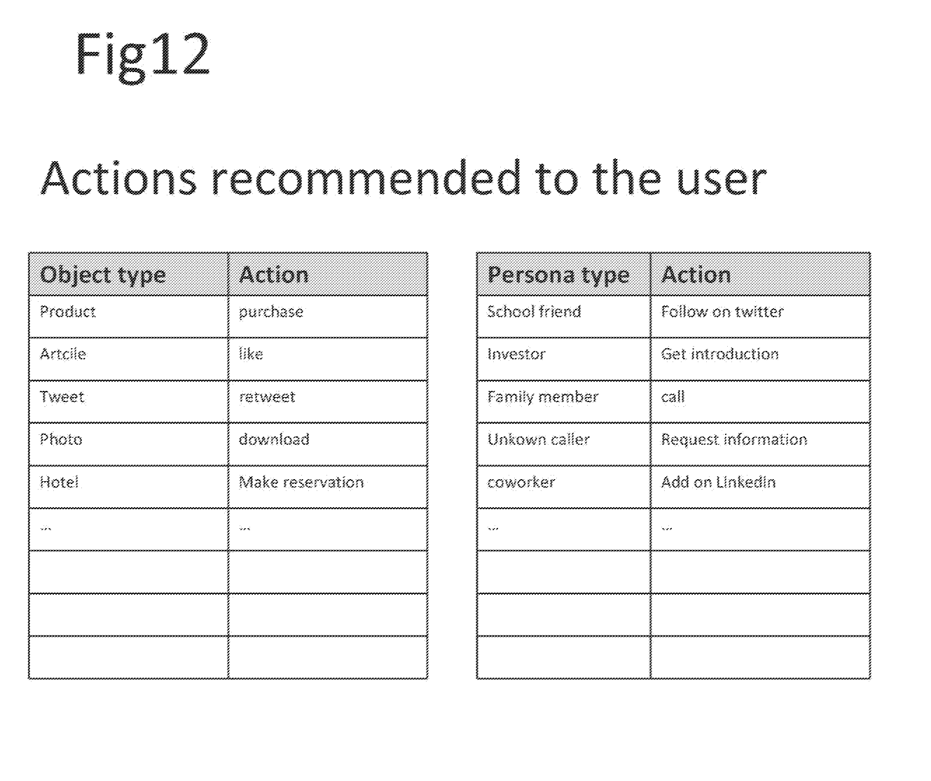

Finally, as shown in FIG. 12 the system suggests actions to the user that change the relationship between the user and the object (e.g., “buy it”), the user and a persona (e.g., “add as friend”), the object and a persona (e.g., “share article with friend”) or two personas (e.g., “introduce them”).

Below are examples, how the system considers a user's social context to find the ‘missing link’ when other types of information are provided as input.

Understanding an Individual's Background

A user from San Francisco is attending a dinner party of his high school friend in New York. He recognizes a person from a business conference he attended a few weeks ago but does not remember the name nor the person's background. Using his mobile device he takes a photo of the person and with the mobile social context application the consults the persons background. Based on the photo the application provides the user with information about shared interests, companies and locations. It also shows the user the presentation slides from the conference of the speaker just published on the conference web site and re-Tweeted by one of his coworkers. The system may use information available via the Facebook “Timeline” stream to discover and select relevant conversation topics. Reviewing the information the user discovers that he as well as the person of interest used to play competitive tennis in high school and that the person actually invested in a company together with one of his company's advisers. He realizes that there might be a business opportunity and after playing a game of tennis the next day he proposes him to work together.

Alternatively, the system can be implemented to suggest conversation topics. For example, the user provides a photo, social networking id, phone number, or some other identifier, and the system returns the most popular (e.g., top three) conversation topics, based on time and strength of affiliation relevancy.

The above example illustrates a case when the user and a persona are given or inferred, and the social context system finds relevant objects. (FIG. 10).

In this case, instead of extracting object vectors, the system extracts identifiers, finds one or more personas, and uses their social context to identify strongly related object vectors. The objects with highest relationship values, e.g., ranked by time, location, activity, and other scores, are selected for further interaction.

Identifying Individuals at Social Gatherings

A user, who's new to his job, is attending a conference with more then 2000 attendees in Berlin. The web site of the conference only provided limited information on attendees such as names and current job positions. Using his tablet, the user consults his “social context.” Based on the user's location, (determined using any geo-location based application such as Foursquare), his confirmed event assistance using a service such as Plancast, and his personal background (interests, work history, etc.) the social context system provides a list of people he knows that are also attending the event and are relevant to his job and personal interests. In a particular embodiment, he may also discover business partners of his former co-workers. Additionally, he may identify friends that are visiting or now living in Berlin for personal reasons, unrelated to the conference. Using the social context application he can email potential business contacts and contact his friends.

The above example illustrates a case when the user, persona identifiers, and some object vectors are known. With this input, the social context helps the user to discover people and their contact information relevant to the user's current location, activity and/or interests.

In some implementations the user is enabled to set up category prioritization for discovered contacts, such as business, investment, fun, and etc. The system may also use real-time data, e.g. GPS or a user's “friending pattern” at the time of the event, to prioritize selection.

Discovering New Bands

A teenage user is a fan of a certain genre of music and often browses YouTube to discover new bands and songs. While viewing a video of one of his favorite bands, he consults “social context” and discovers that one of his best friends that shares his passion for similar music recently commented on an unknown band on a different social network. He follows the link(s) and his social context application notifies him that a former classmate is a member of the band. He may now contact the band member using the messaging system of the social network directly from the social context application, and initiate a “follow” of the band on Twitter. He may also initiate tweets about his discovery with a single click.

Receiving a Call from an Unknown Caller

An individual is driving to a meeting while talking to his wife on a hands-free mobile device when he receives a call from an unrecognized number. Typically, this individual would not interrupt his call, nor call back unknown numbers unless the called left a message. In this case, the “social context” application automatically pulls up information about the incoming number and may indicate that this caller is related to a known person such as the assistant of the person he is meeting with. It may also indicate that he has received an email from the caller he has not yet read. He decides to accept the call and is informed that the location of the meeting has changed. He then decides to call the person he is meeting to reschedule for next week. Looking up the name in the mobile phones address book he finds the persons email but not the phone. By pressing his “social context” button, he receives more information about the person including the persons Skype ID, phone number, and other information, which may be sued to call and reschedule the meeting.

In another example, while watching his favorite sports team on TV a user consults his “social context” on his tablet and discovers that two of his high school friends are actually fans of the opposite team and joins them in a video chat room. He also sees that one of his friends is at a nearby sports bar and likely to be watching the same game. He goes over to the sports bar to watch the game with his friend, during which they are able to chat with their high school friends online. Others may join the chat room after going through a similar discovery process with their social context application.

In yet another example, while driving a user initiates the “social context” application on his mobile device, and discovers that a high school friend recently surfed a surf spot on the side of the road they used to surf together as teenagers. He also discovers that a coworker recently reviewed a hotel that is located in his destination city and other friends are spending their vacation with kids in camping on a close by beach. He decide to stay over night at the hotel and camp with the other families on the camp ground which also received great review from a few friends on a surf spot guide.

Improving Contact Information

A user looks up a person using the social context application. The application provides the user with a list of the social networks, applications, games, etc. that this person subscribes to, plays, or otherwise interacts with on a regular basis. The application may also indicate the person's status within each network as well as an overall score representing the strength or similarity of the person to the user's own profile. The application may then recommend the user (a) join different networks based on the other persons profile, (b) request a connection to the person, and/or (c) initiate communications with the person. The application may also suggest the same actions based upon the network membership and communication patterns of other users that share certain connections.

In some implementations, the end user is charged directly for the use of “social context,” e.g., by a one-time licensing fee, a per transaction fee, or a recurring service charge. In the tablet scenario described above, the tablet may have purchased a mobile application for his cellphone with a one-time charge or signed up for a web-based version for a monthly fee. The payment may also enable the user to access additional features, faster processing or the ability to manage more information.

Third parties may also purchase advertising space within the “social context” application. Advertisers can target messages based on user profiles, the information the users accessed, browsing history, social connections, activities of other personas, current location or any other data that can be obtained by the system. The advertiser may then be charged for the display, clicks, actions or purchases generated by the advertising. For example a company may advertise its new tablets to males between 20 and 40 years of age, that live in or around San Francisco, who have recently visited at least two pages with information about tablets, have at least one friend who previously bought a similar or the same product, between 6 PM and 10 PM, but only when viewing a competitors product. The company then pays based on a combination of displaying the advertisement, clicks attributed to the advertisement, and/or purchases of the product.

In other embodiments, the system may be combined with existing or proprietary affiliate programs where revenue is typically generated from commissions when users purchase a product or service. This differs from the standard advertising model because third parties cannot influence which message is presented and where and when it appears. Visitors are driven “organically” primarily through information provided in the social context without the influence of direct advertisement. For example, a user may be presented with a friend of a friend's review of a tablet on Amazon. After reading the review, the user purchases the tablet and Amazon pays a commission or adds points to the reviewer's account.

As used herein, references to “computer(s),” “machine(s)” “systems” and/or “device(s),” may include, without limitation, a general purpose computer that includes a processing unit, a system memory, and a system bus that couples various system components including the system memory and the processing unit. The general purpose computer may employ the processing unit to execute computer-executable program modules stored on one or more computer readable media forming the system memory. The program modules may include instructions, routines, programs, objects, components, data structures, etc. that perform particular tasks or implement particular abstract data types. The “computer(s),” “machine(s)” and/or “device(s),” may assume different configurations and still be consistent with the invention, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

Moreover, as used herein, references to “a module,” “modules”, “application(s)” “function”, and/or “algorithm” generally mean, but are not limited to, a software or hardware component that performs certain tasks. A module may advantageously be configured to reside on an addressable storage medium and be configured to execute on one or more processors. A module may be fully or partially implemented with a general purpose integrated circuit (IC), co-processor, field-programmable gate array (FPGA), or application-specific integrated circuit (ASIC). Thus, a module may include, by way of example, components, such as software components, object-oriented software components, class libraries, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or be further separated into additional components and modules. Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (PBX). In any of these cases, implementation may be achieved either by writing applications that are native to the chosen platform, or by interfacing the platform to one or more external application engines.

The application is connected to the client by way of a network. Networks consistent with exemplary embodiments of the invention, including network 300, may be a wired or wireless local area network (LAN) or wide area network (WAN), a wireless personal area network (PAN), and other types of networks. When used in a LAN networking environment, computers (such as a computer executing the application, or the client device) may be connected to the LAN through a network interface or adapter. When used in a WAN networking environment, computers typically include a modem or other communication mechanism. Modems may be internal or external, and may be connected to the system bus via a user-input interface, or other appropriate mechanism. Computers, such as the client device and a server running the application, may be connected over the Internet, an Intranet, an Extranet, an Ethernet, or any other network that facilitates communications. In addition, any number of transport protocols may be utilized, including, without limitation, the User Datagram Protocol (UDP), Transmission Control Protocol (TCP), Venturi Transport Protocol (VTP), Datagram Congestion Control Protocol (DCCP), Fiber Channel Protocol (FCP), Stream Control Transmission Protocol (SCTP), Reliable User Datagram Protocol (RUDP), and Resource ReSerVation Protocol (RSVP). For wireless communications, communications protocols may include Bluetooth, Zigbee, IrDa, or other suitable protocol. Furthermore, components of the systems described herein may communicate through a combination of wired or wireless paths.

In one exemplary embodiment, a user may interface with a client device via a user interface. The user may enter commands and information through the user interface, such as through input devices such as a keyboard, a touch-screen, and/or a pointing device—e.g., a mouse, trackball or touch pad. In one embodiment, the user interacts with the application and its various component modules using these and other input devices in conjunction with a graphical user interface (GUI) provided on a client device, or hosted on a server (such as a server also hosting the application), and accessed by a terminal or internet browser local to the client device.

1. A system for discovering relationships among users of a plurality of electronic social networking and messaging platforms, the system comprising:
a memory for storing computer executable instructions; and
a processor for retrieving and executing the computer executable instructions such that when executed cause the processor to further:
identify one or more characteristics and interests of the user;
compile a vector representing the one of more characteristics and interests of the user;
compare the vector with one or more vectors representing identities and interests of other individuals, and based on the comparison identify a subset of the other individuals having a relationship to the user based on one or more of the other individuals identities and interests; and
graphically present an actionable list of the subset of individuals to the user such that the user may select one of the individuals from the list for subsequent communication.
